(19) United States
(12) Patent Application Publication
(10) Pub. No.: US 2024/0399598 A1
(43) Pub. Date: Dec. 5, 2024

(54) LINER AND FOLDING KNIFE WITH BUTTON-LOCK AND FOLDING KNIFE WITH AXIS-LOCK

(71) Applicant: GUANGXI RUIKE OUTDOOR TOOLS MANUFACTURING CO., LTD., Yulin (CN)

(72) Inventors: Gang Liang, Yulin (CN); Xiaoxuan Liang, Yulin (CN)

(21) Appl. No.: 18/622,882

(22) Filed: Mar. 30, 2024

(30) Foreign Application Priority Data
May 31, 2023 (CN) 202321352531.8
Aug. 7, 2023 (CN) 202322100887.9

(51) Int. Cl. B26B 1/10; B26B 1/04

(52) U.S. Cl. CPC B26B 1/10; B26B 1/04

(57) ABSTRACT

Embodiments provide a liner, a folding knife with button-lock and a folding knife with axis-lock. The liner includes a first liner surface and second liner surface provided parallel to each other, and a connecting part connecting upper ends of the first liner surface and the second liner surface; the first liner surface, the second liner surface, and the connecting part are integrally bent and formed. Specifically, the first liner surface, the second liner surface and the connecting part can be bent and formed integrally by a metal sheet to facilitate the production and processing of the liner. The whole stability and strength of the folding knife can be enhanced when installing the liner onto the folding knife. At the same time, there is no need to use the limiting pin to space the two liner surfaces, such that the structure is simpler and easier to install.

### CROSS REFERENCE TO RELATED APPLICATIONS

This application claims priority to Chinese Patent Application Number 202321352531.8, filed May 31, 2023, and Chinese Patent Application Number 202322100887.9, filed Aug. 7, 2023, the entire disclosures of which are incorporated herein by reference in their entireties.

### TECHNICAL FIELD

The present disclosure relates to the technical field of cutting tools, and specifically, relates to a liner, a folding knife with a button-lock and a folding knife with an axis-lock.

### BACKGROUND

Folding knife has the characteristics of portability, practicality and so on, is one of the tools often used in people's life. The locking methods of the folding knife currently include five kinds, e.g. back lock, liner lock, one-piece lock, axis lock structure and bolster lock. Each locking method has its own characteristics, and there are a variety of corresponding insurance mechanism designs. Currently on the market, the folding knife usually includes handles, liners and a blade. The blade is rotatably assembled between the liners, two handles are provided and fixed on both sides of the liners. Most of the liners have split forms, and blade limit pins, spacers and other accessories. The form of folding knife has redundant accessories, such that the manufacturing costs can be higher.

### SUMMARY

The present disclosure, in order to overcome at least one of the defects described in the above prior art, provides a liner, a folding knife with a button-lock and a folding knife with a axis-lock, with a simple structure to reduce production costs. The liner is bent and formed integrally, such that the machining process is simple, facilitating to process and produce.

To this end, the present disclosure adopts the following technical solutions: a liner, comprising a first liner surface and a second liner surface provided parallel to each other, and a connecting part connecting upper ends of the first liner surface to the second liner surface, the first liner surface, the second liner surface, and the connecting part being integrally bent and formed.

After adopting the above technical solution, the beneficial effect of the present disclosure is as follows: since the liner can be bent from a metal plate, it is convenient for the production and processing of the liner. When installing the liner to the folding knife, it improves the entire stability and strength of the folding knife, and at the same time, it can eliminate the need to use the limiting pins to space the two liner surfaces, making the structure easier to install.

A folding knife with a button-lock comprises the above liner, a blade, a handle and a button-lock structure, wherein one end of the blade comprises a connecting end rotatably connected to a front end of the handle and provided with a driving part for driving the blade to rotate; and an open-locking surface and a close-locking surface configured for cooperating with the button-lock structure; the liner is fixedly mounted on the front end of the handle and the liner is provided with an opening stop and a closing stop for cooperating with the connecting end; the handle comprises a first handle and a second handle provided parallel to each other, between the first handle and the second handle, a gap for mounting the blade is formed; ends of the first handle and the second handle are fixedly connected by the liner, and another ends are fixedly connected by a spacer; the first liner surface and the second liner surface are fixedly connected to the first handle and the second handle respectively.

After adopting the above technical solution, the beneficial effect of the present disclosure is as follows: the folding knife with a button-lock is provided with the liner, and the opening stop and the closing stop are provided on the liner, the opening stop and the closing stop are respectively offset by the connecting end, in order to be able to restrict the opening and closing of the blade respectively, so as to make the blade rotate accurately to the state of fully opening or fully closing. Compared with the existing folding knife with a button-lock structure, there is no need to set a limit post to limit the rotation of the blade. It has a simple structure, making production costs reduced. The liner adopts an integrate bending and forming process, such that the machining process is simple, facilitating to process and produce.

A folding knife with an axis-lock comprises the above liner, a blade, a handle and an axis-lock structure, wherein one end of the blade has a connecting end rotatably connected to a front end of the handle; the connecting end is provided with an open-locking surface, a close-locking surface, an offset part and a pushing peg; the axis-lock structure slidingly cooperates with the handle, and the axis-lock structure is capable of cooperating with the open-locking surface and the close-locking surface to lock the blade in a fully open state or in a fully closed state; the liner is fixedly mounted on the front end of the handle, the liner is provided with an opening stop; when the opening stop is offset with the offset part, or when the pushing peg is offset with an edge of the handle, the opening stop is able to limit a rotation of the blade; the handle comprises a first handle and a second handle provided parallel to each other, between the first handle and the second handle, a gap for mounting the blade is formed; ends of the first handle and the second handle are fixedly connected by means of the liner and another ends are fixedly connected by means of a spacer; the first liner surface and the second liner surface are fixedly connected to the first handle and the second handle respectively.

After adopting the above technical solution, the beneficial effect of the present disclosure is as follows: compared with the prior art, a folding knife with an axis-lock of the present disclosure is provided with the liner provided with the opening stop, such that when the knife is opened, the offset part on the blade is able to offset the opening stop to limit the opening of the blade; and when the knife is closed, the pushing pin on the blade is able to offset the edge of the handle to limit the closing of the blade, such that the blade is precisely rotated to a fully open state or a fully closed state. Compared with the existing folding knife with a button-lock structure, there is no need to provide a limit post to limit the rotation of the blade. The structure is simple, and the production cost is reduced. The liner adopts an integrate bending and forming process, such that the machining process is simple, facilitating to process and produce.

### BRIEF DESCRIPTION OF DRAWINGS

FIG. 1 is a schematic structural diagram of a liner according to embodiment 1;

FIG. 2 is a schematic structural diagram of a liner according to embodiment 1;

FIG. 3 is a schematic structural diagram of a folding knife with a button-lock in a fully open state according to embodiment 2;

FIG. 4 is a schematic structural diagram of a folding knife with a button-lock in a fully closed state according to embodiment 2;

FIG. 5 is a schematic structural diagram of a connection between the blade and pins according to embodiment 2;

FIG. 6 is a schematic structural diagram of the liner according to embodiment 2;

FIG. 7 is a schematic structural diagram of a blade according to embodiment 2;

FIG. 8 is a schematic structural diagram of a first handle according to embodiment 2;

FIG. 9 is a schematic structural diagram of a second handle according to embodiment 2;

FIG. 10 is a schematic diagram of an installation structure of a button-lock structure according to embodiment 2;

FIG. 11 is a schematic structural diagram of a folding knife with an axis-lock in a fully open state according to embodiment 3;

FIG. 12 is a schematic structural diagram of the folding knife with an axis-lock in a fully closed state;

FIG. 13 is a schematic structural diagram of the folding knife with an axis-lock in a fully closed state after removing the first handle;

FIG. 14 is a schematic structural diagram of the liner according to embodiment 3;

FIG. 15 is a schematic structural diagram of the blade according to embodiment 3;

FIG. 16 is a schematic structural diagram of the first handle according to embodiment 3;

FIG. 17 is a schematic structural diagram of the second handle according to embodiment 3.

Note of the reference signs:

1, blade; 2, button-lock structure; 3, liner; 4, connecting end; 5, driving part; 6, open-locking surface; 7, close-locking surface; 8, opening stop; 9, closing stop; 10, first handle; 11, second handle; 12, spacer; 13, first liner surface; 14, second liner surface; 15, connecting part; 16, first limit groove; 17, second limit groove; 18, avoidance groove; 19, shaft; 20, spring; 21, pressing part; 22, locking part; 23, avoidance part; 24, clip fastener; 25, pin; 26, limit tab; 27, mounting hole; 28, mounting slot hole; 29, mounting slot; 30, perforation; 31, clip fastener slot; 32, pin hole; 33, fixing hole; 34, avoidance space; 35, axis-lock structure; 36, offset part; 37, pushing peg; 38, slide groove; 39, pushing part; 40, arc guiding part.

### DESCRIPTION OF EMBODIMENTS

The present disclosure is explained in further detail below in conjunction with the figures.

This specific embodiment is only an explanation of the present disclosure, which is not a limitation of the present disclosure, and the person skilled in the art may make modifications to this embodiment without inventive contribution as needed after reading this specification, but as long as it is within the scope of the claims of the present disclosure it is protected by the patent law.

It should be noted that when an element is referred to as “fixed to” or “provided on” another element, it may be directly on the other element or indirectly on the other element. When an element is referred to as “connected to” another element, it may be connected directly to the other element or indirectly to the other element.

It should be understood that the terms “length”, “width”, “upper”, “lower”, “front”, “rear”, “left”, “right”, “vertical”, “horizontal”, “top”, “bottom”, “inside”, “outside” and the like indicate orientations or positional relationships based on those shown in the figures, and are intended only to facilitate the description of the present disclosure and to simplify the description, and are not intended to indicate or imply that the device or element referred to must have a particular orientation, be constructed and operated in a particular orientation, and therefore are not to be construed as a limitation of the present disclosure.

Furthermore, the terms “first” and “second” are used for descriptive purposes only and are not to be understood as indicating or implying relative importance or implicitly specifying the number of technical features indicated. Thus, a feature defined with the terms “first”, “second” may expressly or impliedly include one or more such features. In some descriptions of the present disclosure, “more than one” means two or more, unless otherwise expressly and specifically limited.

### Embodiment 1

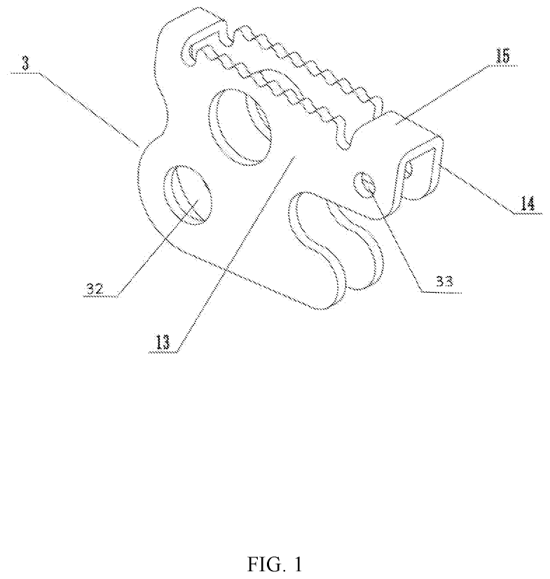

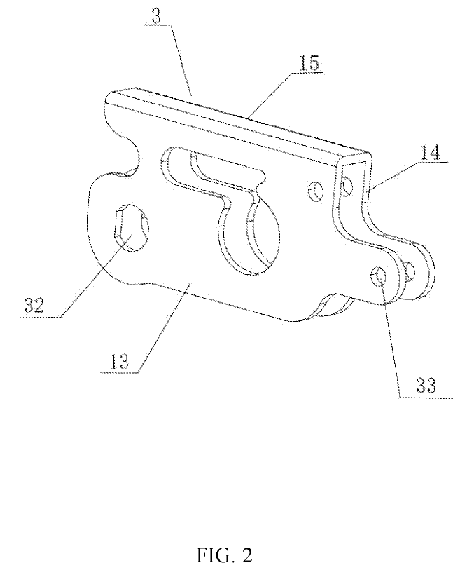

The present embodiment relates to a liner, as shown in FIGS. 1 and 2, comprising: a first liner surface 13 and a second liner surface 14 provided parallel to each other, and a connecting part 15. The connecting part 15 is configured for connecting the upper ends of the first liner surface 13 with the second liner surface 14. The first liner surface 13, the second liner surface 14, and the connecting part 15 are integrally bent and formed. The liner 3 is a metal product. The first liner surface 13 and the second liner surface 14 are both provided in a flat plate shape. Specifically, the first liner surface 13, the second liner surface 14, and the connecting part 15 can be bent and formed integrally by a metal sheet, so as to facilitate the production and processing of the liner 3. When the liner 3 is mounted on the folding knife, the overall stability and strength of the folding knife can be enhanced, and at the same time, it is possible to eliminate the need for the use of limit pins to space the two liner surfaces, such that structure can be simpler and installation can be easier.

In the embodiment, the liner 3 is applied to the folding knife, and in order to facilitate the saving of materials, the length of the liner 3 is less than the length of the handle of the folding knife. Preferably, the length of the liner 3 is less than or equal to one-half of the length of the handle.

Further, in order to facilitate to rotatably assemble the blade 1 of the folding knife on the two liner surfaces by means of the pins 25, the first liner surface 13 and the second liner surface 14 are provided with pin holes 32 opposite to each other. Optionally, each pin hole 32 is in a D shape. To facilitate fixed installation between the liner 3 and the handle, at least one fixing hole 33 is provided on the first liner surface 13 and the second liner surface 14, and a screw is able to penetrate the fixing hole 33 to fix the liner 3 to the handle.

When the folding knife with a button-lock of the embodiment needs to be opened, the pushing part 39 of the shaft 19 can be driven by the thumb to make the shaft 19 move backwardly toward the connecting end 4, such that the shaft 19 can be separated from the close-locking surface 7, and then the pushing peg 37 can be driven to drive the blade 1 to forwardly rotate and make the shaft 19 to move along the arc guiding part 40 along the edge of the connecting end 4. When the blade 1 is rotated to the point where the offset part 36 is in contact with the opening stop 8, the opening stop 8 limits the forward rotation of the blade 1, and at the same time, under the action of elastic force of the spring 20, it is possible to drive the shaft 19 move towards the open-locking surface 6, and make the shaft 19 able to maintain a state of offset with the open-locking surface 6, so as to limit the reverse rotation of the blade 1, so as to maintain a stable open state of the blade 1.

When it is necessary to fold the blade 1, the pushing part 39 of the shaft 19 can be driven by the thumb to move the shaft 19 backwardly toward the connecting end 4, such that the shaft 19 is disengaged from the open-locking surface 6, and then the blade 1 is driven to reversely rotate and cause the shaft 19 to move along the arc guiding part 40 on the edge of the connecting end 4, so as to be able to limit the reverse rotation of the blade 1. When the blade 1 is rotated to the extent that the pushing peg 37 is offset the edge of the first handle 10, the reverse rotation of the blade 1 is limited, and under the elastic force of the spring 20, the shaft 19 is enabled to move towards the connecting end 4 and offset the close-locking surface 7, thereby limiting the forward rotation of the blade 1 to maintain a stable close state of the blade 1.

### Embodiment 2

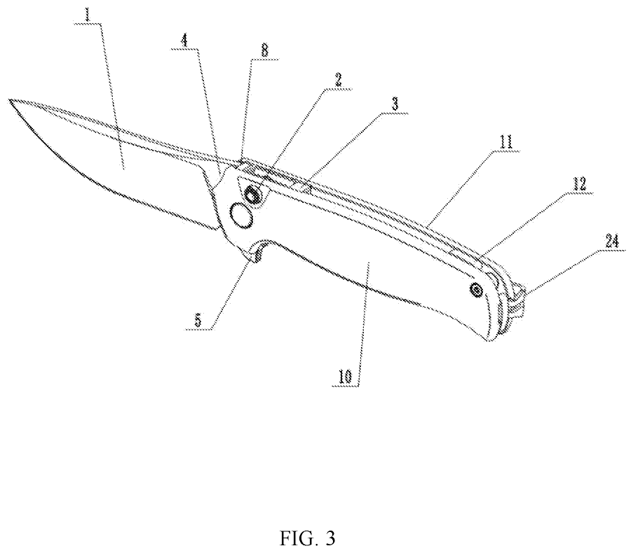

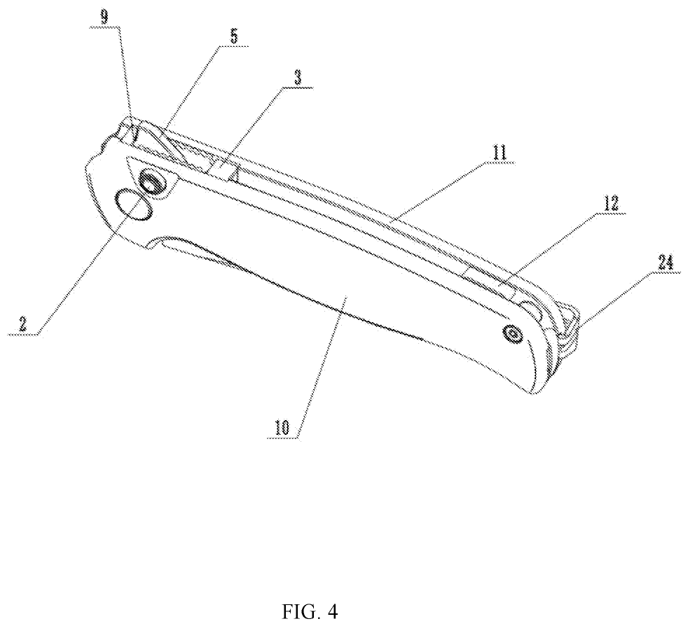

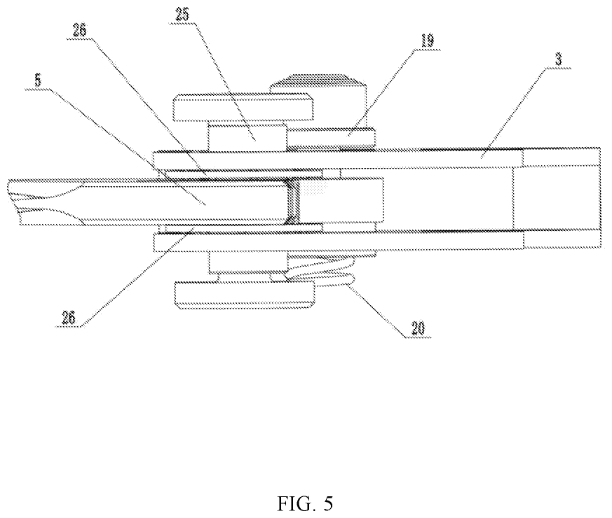

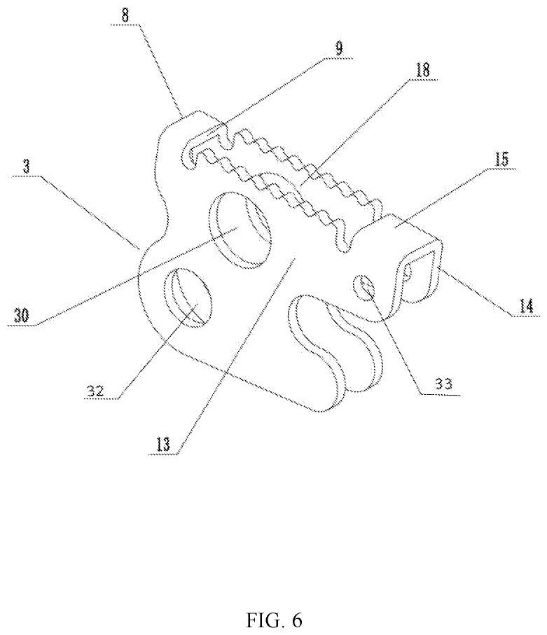

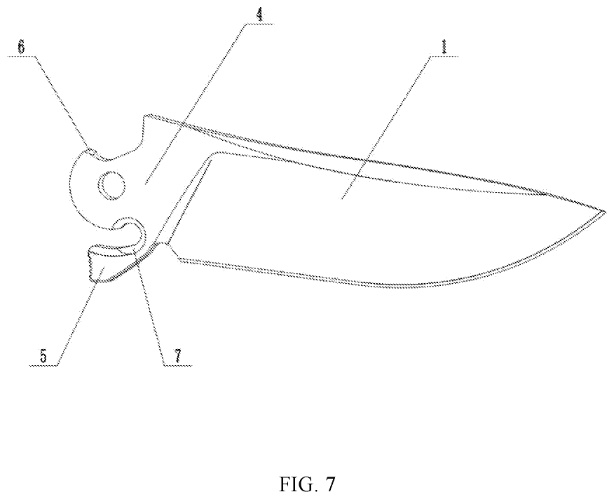

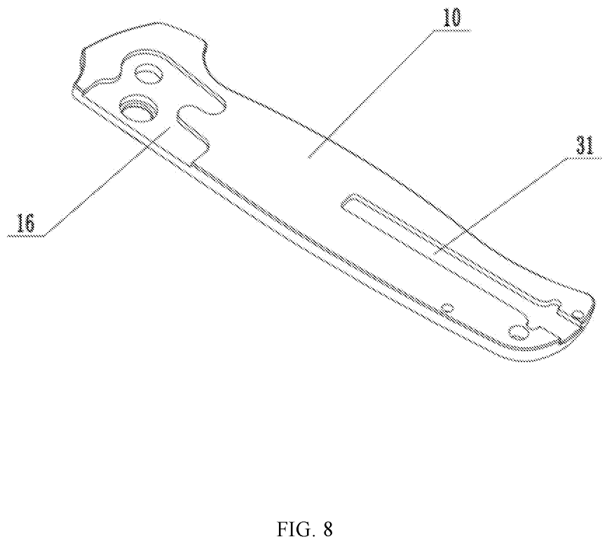

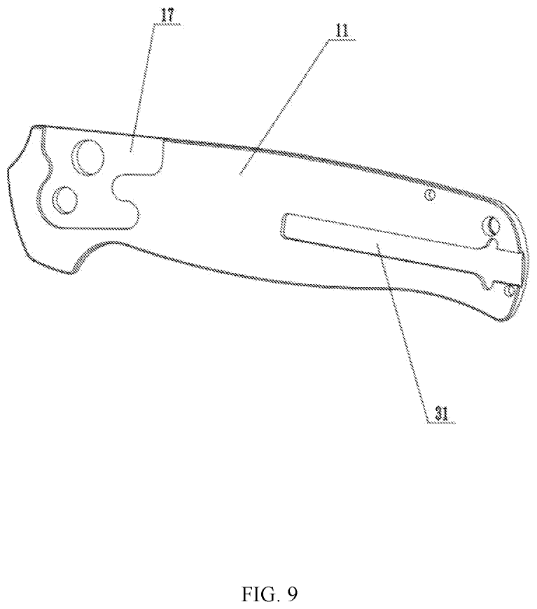

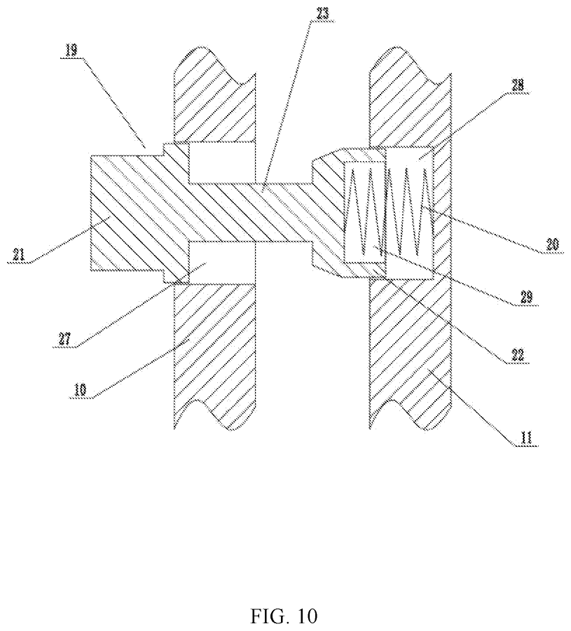

This embodiment is an improvement based on embodiment 1. A folding knife with a button-lock, as shown in FIGS. 3-10, in embodiment 1, comprises the liner 3, the blade 1, the handle and the button-lock structure 2, wherein one end of the blade 1 comprises a connecting end 4 that is rotatably connected to the front end of the handle. The connecting end 4 is provided with a driving part 5, an open-locking surface 6 and a close-locking surface 7. The driving part 5 is used to drive the blade 1 to rotate. The open-locking surface 6 and the close-locking surface 7 are used to cooperate with the button-lock structure 2. The liner 3 is fixedly installed on the front end of the handle, and the liner 3 is provided with an opening stop 8 and a closing stop 9 that cooperate with the connecting end 4. By the method that the connecting end 4 respectively abutting the opening stop 8 and the closing stop 9, the opening and closing of the blade 1 can be limited respectively, so that the blade 1 can accurately rotate to a fully open or a fully closed state. Compared with the existing folding knife with a button lock structure 2, there is no need to set a limit post to limit the rotation of the blade 1, the structure is simple, and the production cost is reduced. Moreover, the open-locking surface 6 adopts the grinding process to process the inclined surface, which can avoid large processing errors on the locking surface and structural instability, such as failure to lock in place or accidental release.

The handle includes a first handle 10 and a second handle 11 arranged parallelly to each other. A gap for installing the blade 1 is formed between the first handle 10 and the second handle 11, so that the blade 1 can be completely folded into the gap when closed.

Specifically, one end of the first handle 10 and the second handle 11 are fixedly connected through the liner 3, and the other end is fixedly connected through the spacer 12. The first liner surface 13 and the second liner surface 14 are respectively fixedly connected to the first handle 10 and the second handle 11. The liner 3 and the spacer 12 can respectively play a role of fixing front and rear ends of the first handle 10 and the second handle 11 to improve the stability of the connection between the first handle 10 and the second handle 11, thereby improving the structural strength of the handle.

Further, the mutually facing surfaces of the first handle 10 and the second handle 11 are respectively provided with first limiting concave surface and second limiting concave surface. The first limiting concave surface and the second limiting concave surface are respectively matches the shape of the first liner surface 13 and the second liner surface 14, and the depths of the first limiting concave surface and the second limiting concave surface are the same as the thicknesses of the first liner surface 13 and the second liner surface 14 respectively. When the liner 3 is installed, the first liner surface 13 and the second liner surface 14 are respectively clamped in the first limiting concave surface and the second limiting concave surface, and the surfaces of the first liner surface 13 and the second liner surface 14 are respectively flush with the surface of the first handle 10 and the second handle 11, and then screws pass through the fixing holes 33 to fix the first liner surface 13 and the second liner surface 14 to the first handle 10 and the second handle 11 respectively, thereby realizing the fixing and installation of the liner 3, which features easy assembly and disassembly, and high installation stability.

Furthermore, the connecting part 15 is provided with an avoidance groove 18, and the driving part 5 is movably arranged in the avoidance groove 18, and protrudes out of the handle through the avoidance groove 18, so that the operator can press the driving part 5. When the driving part 5 is rotating, due to the arrangement of the avoidance groove 18, the connecting part 15 will not limit the rotation of the driving part 5.

Optionally, the button-lock structure 2 includes a shaft 19 and a spring 20. The shaft 19 includes a pressing part 21, a locking part 22 and an avoidance part 23. The pressing part 21 and the locking part 22 are respectively arranged at both ends of the shaft 19. The avoidance part 23 is arranged between the pressing part 21 and the locking part 22. The outer diameter of the locking part 22 is larger than the outer diameter of the avoidance part 23, and the locking part 22 passes through the spring 20 to elastically connect with the handle.

Specifically, the first handle 10 is provided with a mounting hole 27, the second handle 11 is provided with a mounting slot hole 28, the shaft 19 passes through the mounting hole 27 and the locking part 22 can extend into the mounting slot hole 28. The locking part 22 is elastically connected to the mounting slot hole 28 through the spring 20. Preferably, the end of the locking part 22 can be provided with a mounting slot 29 to improve the stability of the installation of the spring 20. The close-locking surface 7 can be tapered. The locking part 22 is also provided with a tapered end to facilitate the locking part 22 contacting and matching with the close-locking surface 7. When the spring 20 is not under pressure, the locking part 22 can be pushed out of the mounting slot hole 28 so that the locking part 22 can contact the open-locking surface 6 and the close-locking surface 7 to keep the blade 1 in a fully open or a fully closed state. When the pressing part 21 is pressed, the spring 20 can be compressed, and the locking part 22 is retracted into the mounting slot hole 28. At this time, the avoidance part 23 corresponds to the open-locking surface 6 and the close-locking surface 7. Due to the outer diameter of the avoidance part 23 is smaller than the outer diameter of the locking part 22, so the avoidance part 23 will not contact the open-locking surface 6 and the close-locking surface 7, so that the blade 1 can rotate relative to the handle. In this embodiment, the liner 3 is provided with a perforation 30 for the shaft 19 to pass through.

Optionally, a clip fastener 24 can be installed on the handle to facilitate the carrying of the knife. Preferably, the inner side surfaces of the first handle 10 and the second handle 11 can be provided with clip fastener slot 31. The clip fastener 24 is provided with an installation part that engages with the clip fastener slot 31. The spacer 12 can be locked by screws and tightly fixed on the handle, and after the spacer 12 is fixed, the installation part can be pressed and fixed in the clip fastener slot 31, thereby improving the stability of the installation of the clip fastener 24. Adopting the above installation structure, during the installation process of the clip fastener 24, no screws are required for fixing and the installation structure is simpler.

Furthermore, a pin 25 is fixedly installed at the front end of the first handle 10 and the second handle 11. Two limit tabs 26 arranged parallel to each other are embedded on the pin 25. The limit tabs 26 are arranged between the first liner surface 13 and the second liner surface 14. The connecting end 4 is rotatably arranged between the two limit tabs 26. Specifically, the end of the pin 25 passes through the limit tab 26, the pin hole 32 of the liner 3 and the handle in sequence. The movement of the connecting end 4 along the axis of the pin 25 can be limited by the limit tab 26, thereby reducing the shaking of the blade 1 during use and improving the stability of the installation of the blade 1.

When using the folding knife with a button-lock of this embodiment, you can press the pressing part 21 of the shaft 19 with your thumb to disengage the locking part 22 from the close-locking surface 7, and then push the driving part 5 backward with your index finger to drive the blade 1 to rotate forward. When the blade 1 rotates until the connecting end 4 contacts the opening stop 8, the opening stop 8 limits the forward rotation of the blade 1. At this time, the blade 1 is in a fully open state, and then the thumb releases the pressing part 21. Under the elastic force of the spring 20, the locking part 22 can contact the open-locking surface 6, thereby limiting the reverse rotation of the blade 1 to maintain a stable opening state of the blade 1. When it is necessary to fold the blade 1, press the pressing part 21 of the shaft 19 with your thumb to disengage the locking part 22 from the open-locking surface 6, and then drive the blade 1 to rotate reversely. When the blade 1 rotates until the connecting end 4 contacts the closing stop 9, the closing stop 9 limits the reverse rotation of the blade 1. At this time, the blade 1 is in a completely closed state. Then the thumb releases the pressing part 21, and under the elastic force of the spring 20, the locking part 22 can abuts with the close-locking surface 7, thereby limiting the forward rotation of the blade 1 to maintain a stable closed state of the blade 1.

### Embodiment 3

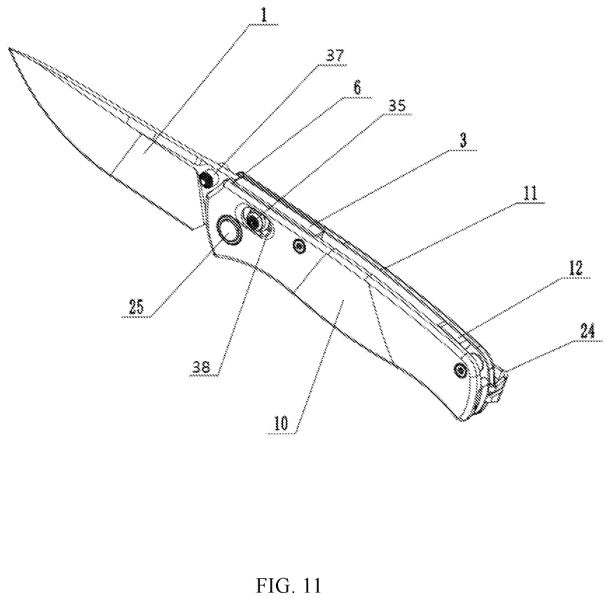

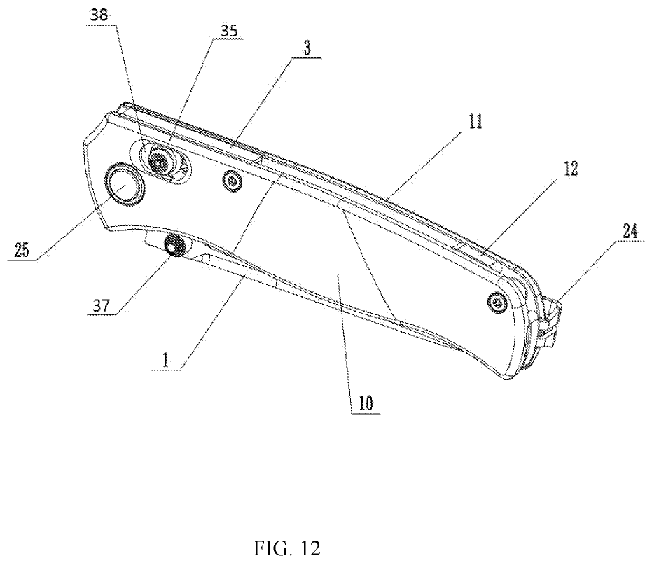

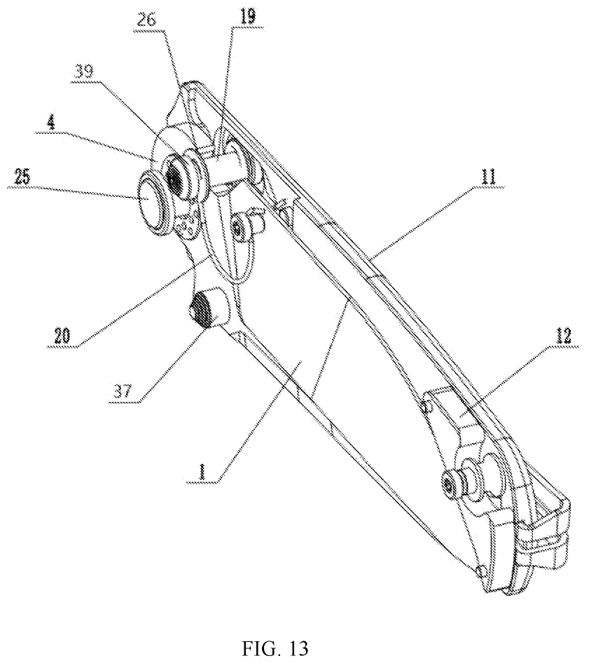

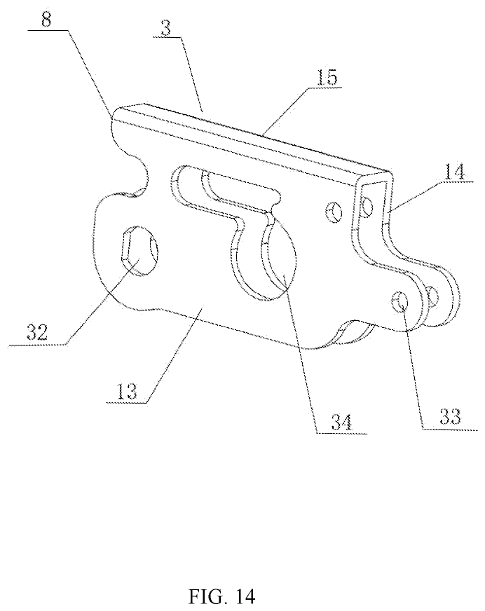

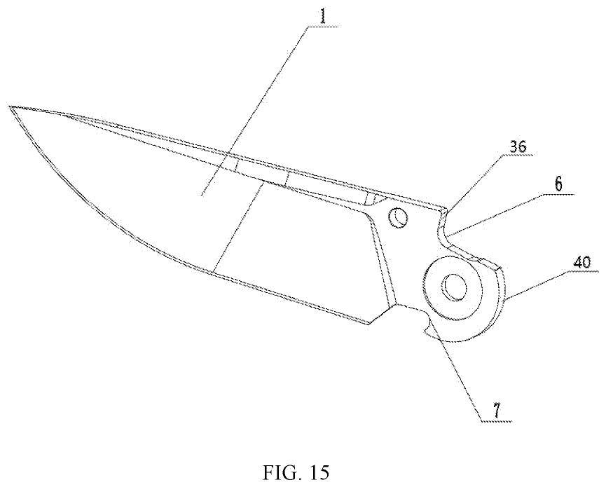

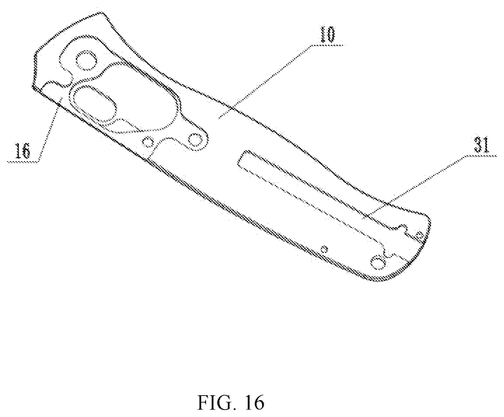

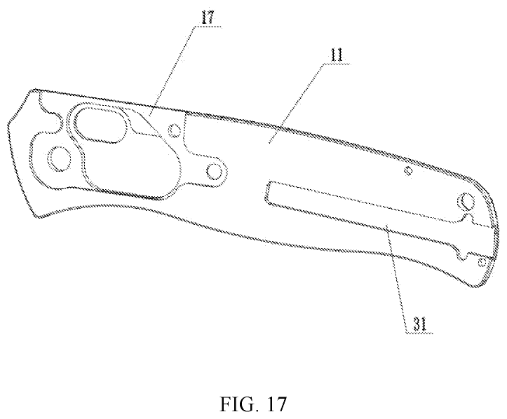

The main difference between this embodiment and embodiment 2 is that: a folding knife with a axis-lock, as shown in FIGS. 11-17, comprises: the liner 3, the blade 1, the handle and the axis-lock structure 35 in embodiment 1. One end of the blade 1 comprises a connecting end 4 that is rotatably connected to the front end of the handle. The connecting end 4 is provided with an open-locking surface 6, a close-locking surface 7, an offset part 36 and a pushing peg 37. The axis-lock structure 35 is slidably matched with the handle, and the axis-lock structure 35 can cooperate with the open-locking surface 6 and the close-locking surface 7 to lock the blade 1 in a fully open state or a fully closed state. The liner 3 is fixedly installed on the front end of the handle, and the liner 3 is provided with an opening stop 8. When opening the knife, the offset part 36 on the blade 1 can contact the opening stop 8 to limit the opening of the blade 1. When closing the knife, the pushing pin 37 on the blade 1 can contact the edge of the handle to limit the closing of the blade 1, so that the blade 1 can accurately rotate to a fully open state or a fully closed state. Compared with the existing folding knife with a button-lock structure 2, there is no need to set a limit post to limit the rotation of the blade 1, the structure is simple, and the production cost is reduced. At the same time, a pushing peg 37 is arranged on the blade 1 to facilitate pushing the blade 1 to rotate relative to the handle. Preferably, the pushing peg 37 can be fixedly installed on the blade 1 through a threaded connection.

Further, the handle includes a first handle 10 and a second handle 11 arranged parallel to each other. A gap is formed between the first handle 10 and the second handle 11 for installing the blade 1, so that the blade 1 can be completely folded into the gap when it is closed. One end of the first handle 10 and the second handle 11 are fixedly connected through the liner 3, and the other end is fixedly connected through the spacer 12. Specifically, the first liner surface 13 and the second liner surface 14 can be fixedly connected to the first handle 10 and the second handle 11 respectively by drilling the fixing holes 33 with screws, eliminating the need for two liner surfaces and liner 3, featuring easy disassembly and assembly and high stability of installation. At the same time, the liner 3 and the spacer 12 can respectively play the role of fixing the front and rear ends of the first handle 10 and the second handle 11 to improve the stability of the connection between the liner 3 and the first handle 10, and between the liner 3 and the second handle 11 respectively, thereby improving the structural strength of the handle.

Preferably, the handle is provided with a slide groove 38. The axis-lock structure 35 includes a shaft 19 and a spring 20. The shaft 19 slidingly matches with the slide groove 38, and both ends of the shaft 19 are respectively provided with pushing parts 39. The pushing parts 39 are protruded on the surface of the handle. One end of the spring 20 is connected to the handle, and the other end is connected to the shaft 19, and under the elastic force of the spring 20, the shaft 19 can maintain a state of mating with the open-locking surface 6 or the close-locking surface 7.

Specifically, both the first handle 10 and the second handle 11 are provided with slide grooves 38, and the two ends of the shaft 19 are slidingly matched with the slide groove 38 respectively. In order to facilitate the installation of the shaft 19, the first liner surface 13 and the second liner surface 14 of the liner 3 are provided with avoidance space 34 for the shaft 19 to pass through, and the two ends of the shaft 19 are also provided with limit tab 26. The two limit tabs 26 can be connected with the each other's opposite surfaces of the first liner surface 13 and the second liner surface 14 respectively, thereby limiting the movement of the shaft 19 along its axial direction to prevent the shaft 19 from coming out of the slide groove 38. By providing the pushing part 39, it is convenient for the operator to push the shaft 19 toward or away from the connecting end 4. When the shaft 19 moves toward the connecting end 4, the shaft 19 can contact and match with the open-locking surface 6 or close-locking surface 7, so that the blade 1 cannot rotate, thereby locking the blade 1 in a fully open state or a fully closed state. When the shaft 19 moves away from the connecting end 4, the shaft 19 can separate from the open-locking surface 6 or the close-locking surface 7, so that the blade 1 can rotate, thereby the opening blade 1 can be closed, or the closed blade 1 can be opened. The spring 20 can be U-shaped, one end of which can be wound and fixed on the shaft 19, and the other end can be clamped and fixed on the handle so that the shaft 19 can maintain the state of contacting and matching with the open-locking surface 6 or close-locking surface 7 under the elastic force of the spring 20, thereby ensuring the stability of the locking.

When the folding knife with button-lock of this embodiment needs to be opened, the pushing part 39 of the shaft 19 can be driven by the thumb, so that the shaft 19 moves away from the connecting end 4, thereby the shaft 19 can be separated from the close-locking surface 7, and then push the pushing peg 37 to drive the blade 1 to rotate forward, and make the shaft 19 move along the arc guiding part 40 on the edge of the connecting end 4. When the blade 1 rotates to the offset part 36 and the opening stop 8, the opening stop 8 limits the forward rotation of the blade 1. At the same time, under the elastic force of the spring 20, the shaft 19 can be driven to move toward the open-locking surface 6, and the shaft 19 can remain the state of in contact with the open-locking surface 6, thereby limiting the reverse rotation of blade 1 to maintain a stable open state of blade 1; When it is necessary to fold the blade 1, the pushing part 39 of the shaft 19 can be driven by the thumb, so that the shaft 19 moves away from the connecting end 4 and the shaft 19 is disengaged from the open-locking surface 6, and then the blade 1 is driven to rotate in reverse direction, and causes the shaft 19 to move along the arc guiding part 40 on the edge of the connecting end 4. When the blade 1 rotates to the pushing peg 37 and contacts the edge of the first handle 10, the reverse rotation of the blade 1 can be limited, and under the elastic force of the spring 20, the shaft 19 can move toward the connecting end 4 and contact the close-locking surface 7, thereby limiting the forward rotation of the blade 1 to maintain a stable closed state of the blade 1.

The above are only to illustrate the technical solutions of the present disclosure rather than limitations. Any other modifications or equivalent replacements made by those skilled in the art in the field to the technical solution of the present disclosure, as long as they do not depart from the spirit and scope of the technical solution of the present disclosure, should be encompassed within the scope of the claims of the present disclosure.

What is claimed is:

1. A liner, comprising a first liner surface and a second liner surface provided parallel to each other, and a connecting part connecting upper ends of the first liner surface to the second liner surface, the first liner surface, the second liner surface, and the connecting part being integrally bent and formed.

2. The liner according to claim 1, wherein the liner is applied to a folding knife, a length of the liner is less than a length of a handle of the folding knife.

3. The liner according to claim 2, wherein the length of the liner is less than or equal to one-half the length of the handle.

4. The liner according to claim 1, wherein the first liner surface and the second liner surface are provided with pin holes opposite to each other.

5. The liner according to claim 1, wherein the liner is a metal product.

6. A folding knife with a button-lock, comprising the liner according to claim 1, a blade, a handle and a button-lock structure, wherein one end of the blade comprises a connecting end rotatably connected to a front end of the handle and provided with a driving part for driving the blade to rotate; and an open-locking surface and a close-locking surface configured for cooperating with the button-lock structure;
the liner is fixedly mounted on the front end of the handle and the liner is provided with an opening stop and a closing stop for cooperating with the connecting end;
the handle comprises a first handle and a second handle provided parallel to each other, between the first handle and the second handle, a gap for mounting the blade is formed;
ends of the first handle and the second handle are fixedly connected by the liner, and another ends are fixedly connected by a spacer; the first liner surface and the second liner surface are fixedly connected to the first handle and the second handle respectively.

7. The folding knife with a button-lock according to claim 6, wherein the first handle and the second handle are provided with a first limiting concave surface and a second limiting concave surface on mutually facing surfaces of the first handle and the second handle respectively, and the first liner surface and the second liner surface are snap-fitted into the first limiting concave surface and the second limiting concave surface respectively, and are secured by means of screws.

8. The folding knife with a button-lock according to claim 6, wherein the connecting part is provided with an avoidance groove, and the driving part is movably provided in the avoidance groove and protrudes outwardly from the handle through the avoidance groove.

9. The folding knife with a button-lock according to claim 6, wherein the button-lock structure comprises a shaft and a spring, the shaft comprising a pressing part and a locking part provided at respective end of the shaft, and an avoidance part provided between the pressing part and the locking part; an outer diameter of the locking part is greater than that of the avoidance part, and the locking part is resiliently connected to the handle by means of the spring.

10. The folding knife with a button-lock according to claim 6, wherein the first handle and the second handle are fixedly mounted with pins at front ends of the first handle and the second handle, the pins are embedded with two limiting tabs provided parallel to each other, the limiting tabs are provided between the first liner surface and second liner surface, and the connecting end is rotatably provided between two of the limit tabs.

11. A folding knife with an axis-lock, comprising the liner according to claim 1, a blade, a handle and an axis-lock structure, wherein one end of the blade has a connecting end rotatably connected to a front end of the handle;
the connecting end is provided with an open-locking surface, a close-locking surface, an offset part and a pushing peg;
the axis-lock structure slidingly cooperates with the handle, and the axis-lock structure is capable to cooperate with the open-locking surface and the close-locking surface to lock the blade in a fully open state or in a fully closed state;
the liner is fixedly mounted on a front end of the handle, the liner is provided with an opening stop; when the opening stop is offset with the offset part, or when the pushing peg is offset with an edge of the handle, the opening stop is able to limit a rotation of the blade;
the handle comprises a first handle and a second handle provided parallel to each other, between the first handle and the second handle, a gap for mounting the blade is formed;
ends of the first handle and the second handle are fixedly connected by means of the liner and another ends are fixedly connected by means of a spacer; the first liner surface and the second liner surface are fixedly connected to the first handle and the second handle respectively.

12. The folding knife with an axis-lock according to claim 11, wherein the handle is provided with a slide groove, the axis-lock structure comprises a shaft and a spring; the shaft slidingly cooperates with the slide groove, the shaft is provided with a pushing part at each end thereof, the pushing part is provided projectingly on a surface of the handle;
one end of the spring is connected to the handle and another end is connected to the shaft; under an action of an elastic force of the spring, the shaft remains in a state of cooperation with the open-locking surface or the close-locking surface.
